(19) United States
(12) Patent Application Publication
(10) Pub. No.: US 2007/0046604 A1
(43) Pub. Date: Mar. 1, 2007

(54) Method for inserting black frames

(76) Inventors: Kuei-Sheng Tseng, Bade City (TW); Chu-Yu Liu, Dongshih Township (TW); Ming-Hung Chen, Kaohsiung City (TW); Wen-Bin Chen, Beidou Township (TW); Tsong-Cheng Lin, Su-ao Township (TW)

Correspondence Address: RABIN & Berdo, PC, 1101 14TH STREET, NW, SUITE 500, WASHINGTON, DC, 20005, US

(21) Appl. No.: 11/400,391

(22) Filed: Apr. 10, 2006

(30) Foreign Application Priority Data
Aug. 24, 2005 (TW) 94128973

(51) Int. Cl. G09G 3/36

(52) U.S. Cl. 345/90

(57) ABSTRACT

A method of inserting black frames is provided. The LCD comprises a pixel, and the pixel comprises a liquid crystal capacitor. Firstly, during a normal-mode period, a common voltage is provided to a first end of the liquid crystal capacitor. Next, a data signal is provided to a second end of the liquid crystal capacitor, so that the liquid crystal capacitor has a first voltage drop. Finally, during a dark-mode period, a first voltage different from the common voltage is provided to the first end of the liquid crystal capacitor to change the voltage at the second end of the liquid crystal capacitor, so that the liquid crystal capacitor has a second voltage drop to drive the pixel in a dark mode during the dark-mode period.

This application claims the benefit of Taiwan application Serial No. 94128973, filed Aug. 22, 2005, the subject matter of which is incorporated herein by reference.

### BACKGROUND OF THE INVENTION

1. Field of the Invention

The invention relates in general to a liquid crystal display (LCD) capable preventing residual images and method thereof, and more particularly to an LCD capable of inserting black frames and method thereof.

2. Description of the Related Art

The liquid crystal display (LCD) forms an image by using a voltage to affect the arrangement of liquid crystal molecules, so that molecular rod is twisted, and the penetration of the light is thus controlled to obtain various colors. Referring to FIG. 1, a wave-pattern diagram of pixel voltages, a common voltage and data signals of a conventional LCD is shown. Period t1 and period t2 are a frame period. The voltage difference between the data signal data and common voltage Vcom0 equals to the pixel voltage Vp which drives pixels. Or, the voltage difference between the data signal data′ and common voltage Vcom0 equal to the pixel voltage Vp′ which drives pixels. The pixel voltage Vp differs with the pixel voltage Vp′ in that the pixel voltage Vp is a negative semi-cycle during the period t1 and is a positive semi-cycle during the period t2, while pixel voltage Vp′ is a positive semi-cycle during the period t1 and is a negative semi-cycle during the period t2. The common voltage Vcom0 maintains at a fixed level.

During a frame period, the pixel voltage is fixed, so that the liquid crystal molecules can rotate to obtain the required penetration of the light, until another pixel voltage is applied to change the optical penetration of the liquid crystal molecules during the next frame period. To achieve the consistency of the overall frame, LCD may have an insufficient display frequency, resulting in blurred images when displaying fast-moving frames.

Of the methods aiming at improving the quality of dynamic frames, the method of inserting black frames into display images provides a feasible solution to resolve the problem of having blurred images when displaying fast-moving frames. Referring to FIG. 2, a wave-pattern diagram of a conventional method of inserting black frames is shown. The method is achieved by changing the voltage values of the scan line and its previous scan line, so that the voltage values of the pixels are changed and black frames are generated due to a coupling effect. However, in order to change the driving voltages of the scan line and its previous scan line, the driving method of the scan driver for controlling the scan-line voltage becomes complicated further increasing the cost.

### SUMMARY OF THE INVENTION

It is therefore an object of the invention to provide an LCD capable of inserting black frames and method thereof so that the problem of blurred image would not occur when the LCD displays dynamic frames.

The invention achieves the above-identified object by providing a method of inserting black frames associated with an LCD. The LCD comprises a pixel, and the pixel comprises a liquid crystal capacitor. Firstly, during a normal-mode period, a common voltage is provided to a first end of the liquid crystal capacitor. Next, a data signal is provided to a second end of the liquid crystal capacitor, so that the liquid crystal capacitor has a first voltage drop. Finally, during a dark-mode period, a first voltage different from the common voltage is provided to the first end of the liquid crystal capacitor to change the voltage at the second end of the liquid crystal capacitor, so that the liquid crystal capacitor has a second voltage drop to drive the pixel in a dark mode during the dark-mode period.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a wave-pattern diagram of pixel voltages, a common voltage and data signals of a conventional LCD;

FIG. 2 is a wave-pattern diagram of a conventional method of inserting black frames;

FIG. 3 is a flowchart of the method for inserting black frames according to the invention;

FIG. 4A is an equivalence circuit diagram of a pixel according to a first embodiment of the invention;

FIG. 4B is an equivalence circuit diagram of a pixel according to a second embodiment of the invention; and

FIG. 5 is a wave-pattern diagram of relevant signals according to pixel embodiments of the invention.

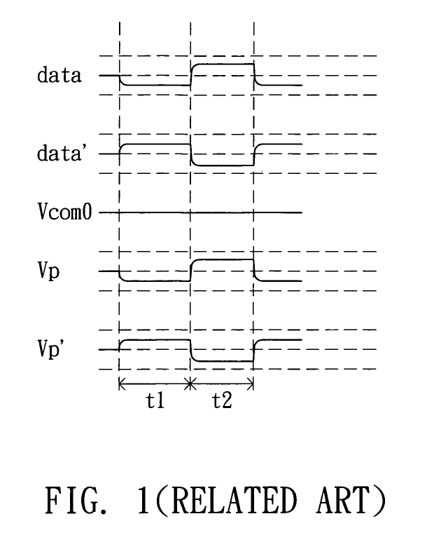

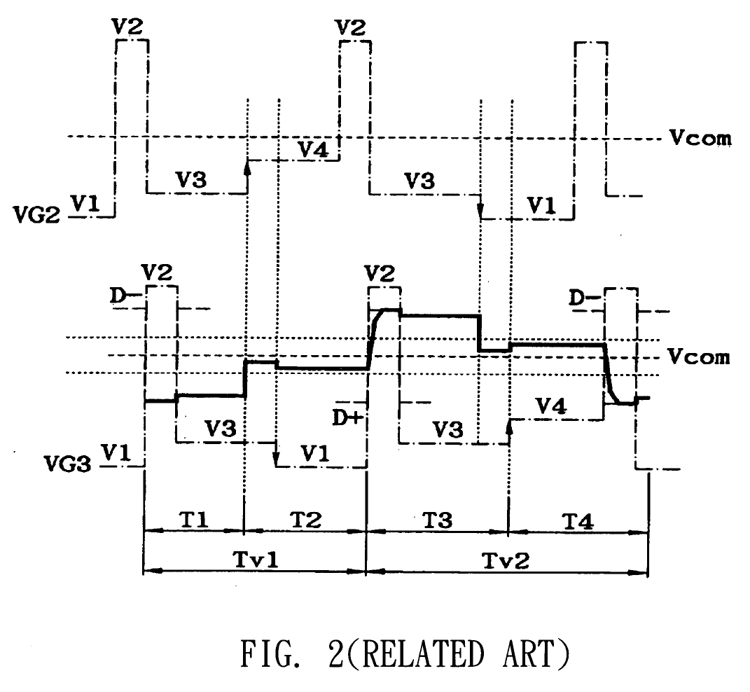

### DETAILED DESCRIPTION OF THE INVENTION

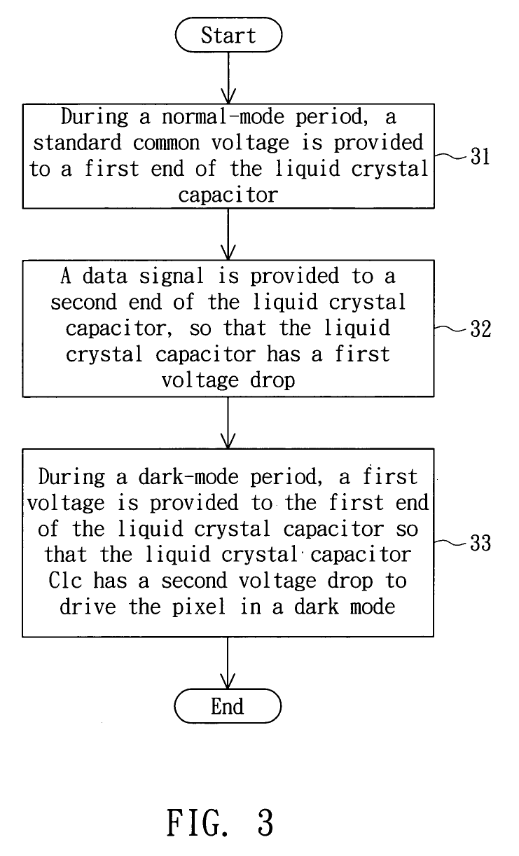

Referring to FIG. 3, a flowchart of the method of inserting black frames according to the invention is shown. The method of inserting black frames is associated with an LCD. The LCD comprises at least a pixel. The pixel comprises a liquid crystal capacitor Clc. Firstly, as shown in step 31, during a normal-mode period, a common voltage is provided to a first end of the liquid crystal capacitor Clc. Next, as shown in step 32, a data signal is provided to a second end of the liquid crystal capacitor Clc, so that the liquid crystal capacitor Clc has a first voltage drop. Finally, as shown in step 33, during a dark-mode period, a first voltage different from the common voltage is provided to the first end of the liquid crystal capacitor Clc to change the voltage at the second end of the liquid crystal capacitor Clc so that the liquid crystal capacitor Clc has a second voltage drop to drive the pixel in a dark mode.

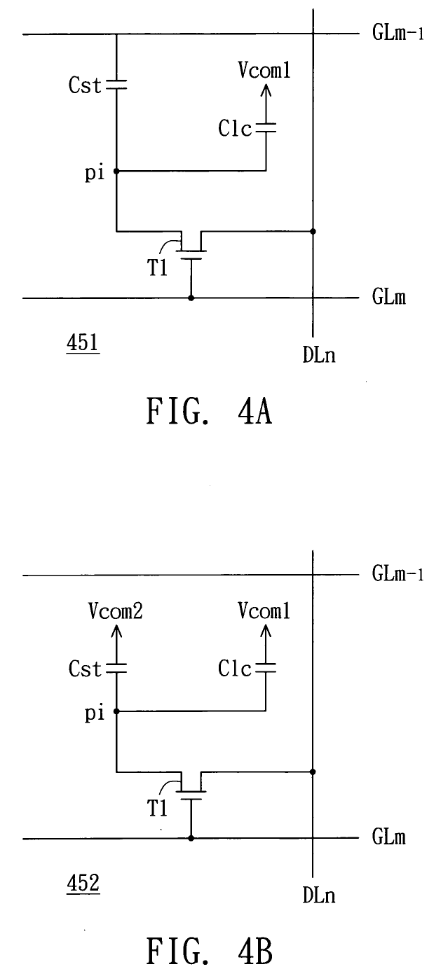

Referring to FIG. 4A, an equivalence circuit diagram of a liquid crystal pixel according to a first embodiment of the invention is shown. The pixel 451 comprises a thin film transistor T1, a liquid crystal capacitor Clc and a storage capacitor Cst. The gate electrode of the thin film transistor T1 receives a scan signal Gm via a scan line GLm. A first end of the liquid crystal capacitor Clc receives a data signal D2 of a data line DLn via the thin film transistor T1. A second end of the liquid crystal capacitor Clc receives a first common voltage signal Vcom1. The first end of the storage capacitor Cst is coupled to the first end of the liquid crystal capacitor Clc, and the second end of the storage capacitor Cst is coupled to the scan line GLm-1 of pixels of previous row, so as to receive the second scan signal Gm-1 which drives a previous row of pixels. The LCD having the pixel 451 drives the pixel 451 by dot inversion or 2-dot inversion for instance.

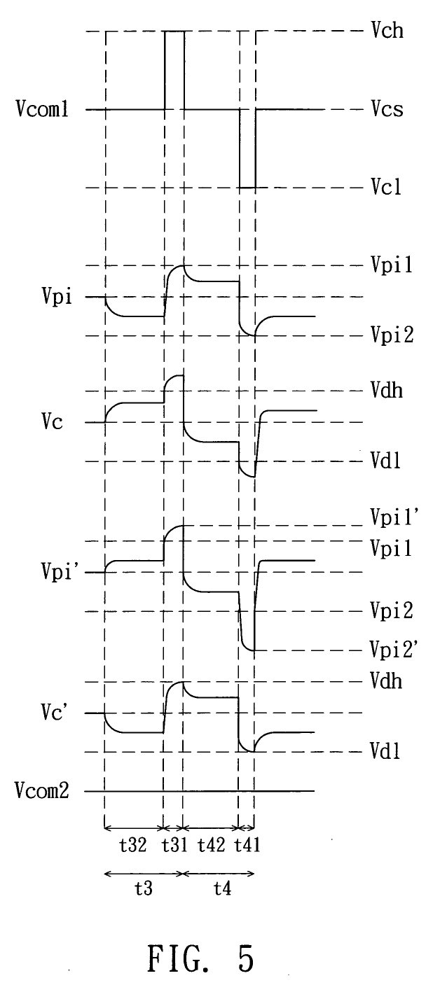

Referring to FIG. 5, a wave-pattern diagram of relevant signals according to the pixel embodiment of the invention is shown. Period t3 and period t4 are a frame period. The period t3 and period t32 are normal-mode periods, while the period t31 is a dark-mode period. In the period t4, the period t42 is a normal-mode period, while the period t41 is a dark-mode period.

It is supposed that in the period t3, the pixel 451 is driven by positive polarity, and in the period t4, the pixel 451 is driven by negative polarity. The embodiment is exemplified by the first common voltage signal Vcom1, a terminal voltage Vpi and a voltage drop Vc as follows. During the normal-mode period t32, the first common voltage signal Vcom1 comprises a common voltage Vcs and is provided to the second end of the liquid crystal capacitor Clc. Meanwhile, the data signal D2 is the terminal voltage Vpi. The voltage drop Vc of the liquid crystal capacitor Clc is the voltage difference between the common voltage Vcs and the terminal voltage Vpi, that is, the first voltage drop in step 32. Meanwhile, the pixel 451 is driven by positive polarity.

During the dark-mode period t31, the first common voltage signal Vcom1 comprises a first voltage Vch, and is provided to the second end of the liquid crystal capacitor Clc. The first common voltage signal Vcom1 is boosted to the first voltage Vch from the first common voltage Vcs, and the terminal voltage Vpi is boosted to the voltage Vpi1 via the coupling effect of the liquid crystal capacitor Clc. However, the value of the voltage Vpi1 can be adjusted according to the increase in the first common voltage Vcs, the value of the liquid crystal capacitor Clc and the value of the storage capacitor Cst. Meanwhile, the second voltage drop (Vc) is not lower than the voltage Vdh. The voltage Vdh is a dark-mode voltage when the pixel 451 is driven by positive polarity.

Suppose the common voltage Vcs is 0V, the first voltage Vch is 10V, and the liquid crystal capacitor Clc and the storage capacitor Cst are substantially the same. During the dark-mode period t31, the second end of the storage capacitor Cst receives the second scan signal Gm-1, which is 0V for instance.

When the pixel 451 is transited from the normal-mode period t32 to the dark-mode period t31, the voltage at the first end of the liquid crystal capacitor Clc is increased by 10V. During the dark-mode period t31, the value of the liquid crystal capacitor Clc and the value of the storage capacitor Cst are substantially the same. Therefore, the voltage at the first end of the liquid crystal capacitor Clc is the terminal voltage Vpi and equals to 5V. The second voltage of the liquid crystal capacitor Clc is the voltage difference between the first voltage Vch and the terminal voltage Vpi, that is, 5V, so that the pixel 451 is displayed in a dark mode.

The main purpose is to change the voltage drop Vc, which really drives the liquid crystal molecules, into the second voltage drop disclosed in step 33 so that the pixel 451 can be displayed in the dark mode. The second voltage drop, which is the voltage difference between the first voltage Vch and the voltage Vpi1, is not lower than the voltage Vdh. The voltage Vdh is the dark-mode voltage when the pixel 451 is driven by positive polarity.

During the normal-mode period t42, the first common voltage signal Vcom1 comprises a common voltage Vcs, and is provided to the second end of the liquid crystal capacitor Clc. The data signal D2 has the terminal voltage Vpi. The voltage drop Vc of the liquid crystal capacitor Clc is the voltage difference between the common voltage Vcs and the terminal voltage Vpi, that is the first voltage drop disclosed in step 32. Meanwhile, the pixel 451 is driven by negative polarity.

During the dark-mode period t41, the first common voltage signal Vcom1 comprises a first voltage Vcl, and is provided to the second end of the liquid crystal capacitor Clc. The first common voltage signal Vcom1 is reduced to the first voltage Vcl from the first common voltage Vcs, and the terminal voltage Vpi is further reduced to voltage Vpi2 via the coupling effect of the liquid crystal capacitor Clc. The value of voltage Vpi2 can be adjusted according to the decrease in the voltage of the first common voltage Vcs, the value of the liquid crystal capacitor Clc and the value of the storage capacitor Cst. The main purpose is to change the voltage drop Vc, which really drives the liquid crystal molecules, into the second voltage drop as disclosed in step 33, so that the pixel 451 can display in a dark mode. The second voltage is the voltage difference between the first voltage Vcl and the voltage Vpi2, and can reach the level of the voltage Vdl at the maximum. The voltage Vdl is the dark-mode voltage when the pixel 451 is driven by negative polarity.

The wave pattern of the first common voltage Vcom1 is designed to alternate between a high value (Vch) and a low value (Vcl) is to avoid the residual current generated by a direct-current (DC) voltage. It can also be designed that in the dark-mode period, the first common voltage Vcom1 maintains at a high value or a low value, or the first common voltage Vcom1 changes to a high value or a low value every two frames in the dark-mode period.

In the period t3, the pixel 451 is driven by negative polarity, and in the period t4, the pixel 451 is driven by positive polarity, and the embodiment is exemplified by the first common voltage signal Vcom1, a terminal voltage Vpi′ and a voltage drop Vc′ as follows. During the normal-mode period t32, the first common voltage signal Vcom1 comprises a common voltage Vcs, and is provided to the second end of the liquid crystal capacitor Clc. Meanwhile, the data signal D2 has the terminal voltage Vpi′. The voltage drop Vc′ of the liquid crystal capacitor Clc is the voltage difference between the common voltage Vcs and the terminal voltage Vpi′, that is, the first voltage drop disclosed in step 32. Meanwhile, the pixel 451 is driven by negative polarity.

During the dark-mode period t31, the first common voltage signal Vcom1 comprises a first voltage Vch, and is provided to the second end of the liquid crystal capacitor Clc. The first common voltage signal Vcom1 is boosted to the first voltage Vch from the first common voltage Vcs, and the terminal voltage Vpi′ is boosted to the voltage Vpi1′ and over the voltage Vpi1 via the coupling effect of the liquid crystal capacitor Clc. The value of the voltage Vpi1′ can be adjusted according to the increase in the voltage of the first common voltage Vcs, the value of the liquid crystal capacitor Clc and the value of the storage capacitor Cst. The main purpose is to change the voltage drop Vc, which really drives the liquid crystal molecules, into the second voltage drop disclosed in step 33, so that the pixel 451 can be displayed in a dark mode. The second voltage drop is the voltage difference between the first voltage Vch and the voltage Vpi1′, and is not lower than the voltage Vdh. The voltage Vdh is the dark-mode voltage when the pixel 451 is driven by positive polarity.

During normal-mode period t42, the first common voltage signal Vcom1 comprises a common voltage Vcs, and is provided to the second end. The data signal D2 of the liquid crystal capacitor Clc, that is, has the terminal voltage Vpi′. The voltage drop Vc′ of the liquid crystal capacitor Clc is the voltage difference between the common voltage Vcs and the terminal voltage Vpi′, that is, the first voltage drop disclosed in step 32. Meanwhile, the pixel 451 is driven by positive polarity.

During the dark-mode period t41, the first common voltage signal Vcom1 comprises a first voltage Vcl, and is provided to the second end of the liquid crystal capacitor Clc. The first common voltage signal Vcom1 is reduced to the first voltage Vcl from the first common voltage Vcs, and the terminal voltage Vpi′ is reduced to voltage Vpi2′ and is over voltage Vpi2 via the coupling effect of the liquid crystal capacitor Clc. The value of the voltage Vpi2′ can be adjusted according to the decrease in the voltage of the first common voltage Vcs, the value of the liquid crystal capacitor Clc and the value of the storage capacitor Cst. The main purpose is to change the voltage drop Vc, which really drives the liquid crystal molecules, into the second voltage drop disclosed in step 33, so that the pixel 451 can be displayed in a dark mode. The second voltage is the voltage difference between the first voltage Vcl and the voltage Vpi2′, and can reach the level of the voltage Vdl at the maximum. The voltage Vdl is the dark-mode voltage when the pixel 451 is driven by negative polarity.

Referring to FIG. 4B, an equivalence circuit diagram of a pixel according to a second embodiment of the invention is shown. The pixel 452 of the present embodiment differs with the pixel 451 of the first embodiment in that the second end of the storage capacitor Cst receives the second common voltage signal Vcom2. The second common voltage signal Vcom2 is fixed at a predetermined level. Other structures and actions of the pixel 452 are the same with the pixel 451 and are not repeated here, for anyone who is skilled in the technology will understand them from the above disclosures.

The LCD capable of inserting black frames and method thereof disclosed in above embodiment of the invention prevent the LCD from producing residual images when displaying dynamic frames, thus improving frame quality significantly. Compared with a conventional method, the present method of inserting black frames is simpler and easier, and does not increase the costs.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for inserting black frames associated with a liquid crystal display (LCD), the LCD comprising a pixel having a liquid crystal capacitor, the method comprising:
during a normal-mode period, providing a common voltage to a first end of the liquid crystal capacitor;
providing a data signal to a second end of the liquid crystal capacitor, so that the liquid crystal capacitor has a first voltage drop; and
during a dark-mode period, providing a first voltage different from the common voltage to the first end of the liquid crystal capacitor to change the voltage at the second end of the liquid crystal capacitor, so that the liquid crystal capacitor has a second voltage drop to drive the pixel in the dark mode.

2. The method according to claim 1, wherein the first voltage is lower than the common voltage.

3. The method according to claim 1, wherein the first voltage is higher than the common voltage.

4. The method according to claim 1, wherein during the normal-mode period of a first frame period, the pixel displays in response to the first voltage drop;
wherein, during the dark-mode period of the first frame period, the first voltage is lower than the common voltage, so that the pixel displays in the dark mode in response to the second voltage drop;
wherein, during the normal-mode period of a second frame period, the pixel displays in response to the first voltage drop, and the second frame period and the first frame period are consecutive frame periods; and
wherein, during the dark-mode period of the second frame period, the first voltage is higher than the common voltage, so that the pixel displays in the dark mode in response to the second voltage drop.

5. The method according to claim 1, wherein the LCD drives the pixel by dot inversion.

6. The method according to claim 1, wherein the LCD drives the pixel by 2-dot inversion.
